(19) United States
(12) Patent Application Publication
(10) Pub. No.: US 2025/0084654 A1
(43) Pub. Date: Mar. 13, 2025

(54) LEVERAGE TOOL FOR REMOVING SHEET MATERIAL FROM STUDS

(71) Applicant: Paul Gregoire Raymond, St. George's (CA)

(72) Inventor: Paul Gregoire Raymond, St. George's (CA)

(21) Appl. No.: 18/883,606

(22) Filed: Sep. 12, 2024

Related U.S. Application Data
(60) Provisional application No. 63/582,118, filed on Sep. 12, 2023.

(51) Int. Cl. E04G 23/08

(52) U.S. Cl. CPC E04G 23/08; E04G 2023/085

(57) ABSTRACT

A leverage tool for removing a drywall from studs includes a handle and a U-shaped body defining tines connected to a cross bar spaced to receive one of the studs therebetween. The tines are curved so that the rear face is convex for engaging against the drywall. The handle is connected to the cross bar at a right angle and includes a lockable swivel coupling allowing the handle to rotate about an axis along the cross bar in a plane at right angles to the cross bar so as to change an angle of the handle relative to the tines. The tines include a substantially flat portion adjacent the base and a curved end portion. A pointed abutment is provided on the end of the handle at the swivel coupling on the cross bar for engaging into the stud to prevent sliding relative to the stud.

This application claims the benefit under 35 USC 119 (e) of Provisional application 63/582,118 filed Sep. 12, 2023.

The present invention is in the field of tools, specifically home building tools and more particularly to a leverage tool which can be used for removing sheet material such as dry wall, wall cladding material and the like from studs to which the material is attached particularly for demolition or replacement.

### BACKGROUND OF THE INVENTION

During home remodeling and/or repairs, it becomes necessary to remove the old drywall sheets from the walls. Currently, this is accomplished by breaking up the drywall sheet with a sledgehammer or other blunt object and removing the pieces. This process is cumbersome and results in a great deal of debris and dust, which complicates the cleanup process and creates a health hazard for the worker who invariably breathes in the dust. Other removal methods include the use of a crowbar the pry the drywall sheet off of the wall studs. However, a crowbar does not provide enough leverage, which results in a greater force needed to be exerted to remove the sheet, and in the worker tire out relatively quickly. In addition, a crowbar focuses the force being exerted on a single point, which results in the sheet tearing or breaking up easily.

Therefore, there is a need in the art for a tool to be used to easily and efficiently remove drywall sheets.

In U.S. Pat. No. 9,657,486 issued May 23, 2017 by the present applicant there is provided a drywall sheet removal tool, comprising: a handle; and a plurality of tines; wherein an angle between a line of the handle and a plane defined by the plurality of tines is between 45° and 90°. Also disclosed are methods of removing a drywall sheet from a wall, the method comprising: creating an opening along the width of the drywall sheet; inserting a plurality of tines of a drywall sheet removing tool of claim 1 into the opening, such that the plurality of tines straddle a stud; and moving a handle of the tool in a direction opposite to a direction the tines are pointing.

### SUMMARY OF THE INVENTION

According to the invention there is provided leverage tool for removing a sheet material from supporting studs comprising:
a handle; and
a generally U-shaped body including a pair of spaced apart tines connected to a cross bar so that the times extend in parallel arrangement away from the cross bar to a remote end of the tine for engagement of the pair of tines side by side into a position behind the sheet material;
the tines being spaced by a distance to receive one of the studs therebetween;
the tines having a front face and a rear face and being curved so as that the front face is concave and the rear face is convex for engaging against the sheet material;
wherein the handle is connected to and extends from the cross bar at a right angle to the cross bar;
wherein the cross bar includes a lockable swivel coupling allowing the handle to rotate about an axis along the cross bar in a plane at right angles to the cross bar so as to change an angle of the handle relative to the tines.

In some cases the remote end of each of the tines comprises a sharp bladed edge. This can be used to cut a slot in the drywall across a wall allowing the tool to be engaged into the slot to remove the material below the slot and then the material above the slot.

For best operation for use with drywall and other similar frangible sheet materials to engage the material and cause it to be removed without tearing, preferably each of the tines is curved with a convex curve facing the material. This curved face can be curved smoothly along the full length or may be preferentially curved at a position adjacent the remote end.

Again to avoid tearing through the material each of the tines preferably has a width of at least 1.0 inch and preferably 1.5 inch and each of the tines preferably has a length of at least 9.0 inches and preferably 12 inches. Also preferably each of the tines has a constant width. In this way the force applied to the rear face of the material is spread over a large area by the width and length or the tines and avoids sufficient pressure at one location to tear through at that location.

In order to bridge a conventional stud to engage the material on either side of the stud preferably the tines have a space therebetween in the range 3.5 to 6 inches.

The tool can be used with the handle at an angle less than 90 degrees to the tines for pulling upwardly to lever off a sheet below the tines with the tines facing downwardly behind the sheet.

Also in view of the possible angle adjustment, the tool can be used with the handle at an angle greater than 90 degrees to the tines for pushing downwardly to lever off a sheet above the tines with the tines facing upwardly behind the sheet.

In accordance with one important feature which can be used independently there is provided a pointed abutment at the cross bar for engaging into the stud to prevent sliding relative to the stud.

In accordance with one important feature which can be used independently the handle comprises an elongate bar with a manually graspable handle portion at the outer end, the handle portion including a cross-bar or quillon to protect the hand.

Disclosed herein are drywall sheet removal tools, comprising: a handle; and a plurality of tines; wherein an angle between a line of the handle and a plane defined by the plurality of tines is in one mode of use between 45° and 90°. Also disclosed are methods of removing a drywall sheet from a wall, the method comprising: creating an opening along the width of the drywall sheet; inserting the pair of tines behind a drywall sheet such that the plurality of tines straddle a stud; and moving a handle of the tool in a direction opposite to a direction the tines are pointing.

The tool is able to lock at the swivel joint using any suitable locking mechanism available to the person skilled in the art at many angles for the user. This allows it to be used for many aspects of demolition including drywall, drywall and a covering layer of plaster, plaster and lathe, siding of many types, shingles etc.

Preferably the pointed abutment at the cross bar extends therefrom in the direction of the front face.

Preferably the pointed abutment is mounted on the handle.

Preferably the cross bar includes a raised hub on the front face and wherein the swivel coupling includes a swivel shaft on which the handle is mounted.

Preferably there is provided a pointed abutment at the cross bar for engaging into the stud to prevent sliding relative to the stud and wherein the pointed abutment is mounted on the handle at the swivel shaft.

Preferably the U-shaped member has a stiffening rib on the rear face each of the tines and the cross bar.

### BRIEF DESCRIPTION OF THE DRAWINGS

FIG. 1 is an isometric view of one embodiment of the disclosed drywall sheet removal tool.

FIG. 2 is a top plan view of the embodiment of the disclosed drywall sheet removal tool partly in section.

FIG. 3 is a side elevational view of the embodiment of the disclosed drywall sheet removal tool partly in section.

FIG. 4 is an isometric view of the disclosed drywall sheet removal tool with the swivel coupling allowing the angle adjustment of the handle.

FIG. 5 is a bottom plan view of the embodiment of the disclosed drywall sheet removal tool.

FIG. 6 is a top plan view of the embodiment of the disclosed drywall sheet removal tool.

### DETAILED DESCRIPTION

The device disclosed herein comprises a forked claw, having at least two tines, and a long handle. The angle between the plane of the claw and the handle is adjustable, such that an efficient fulcrum is created.

Referring to the Figures of the drawings, there is shown an embodiment of the presently disclosed drywall sheet removal tool 100. The tool 100 comprises a claw portion 102 and a handle 104. The claw portion 102 comprises a pair of tines. The embodiment comprises two tines 106 and 108.

In some embodiments, the distance between the tines 106 and 108 is at least two inches, and preferably between 3.5 and 6 inches. Thus in other embodiments, the distance between the tines 106 and 108 is four inches, or slightly wider. In yet other embodiments, the distance between the tines 106 and 108 is greater than four inches.

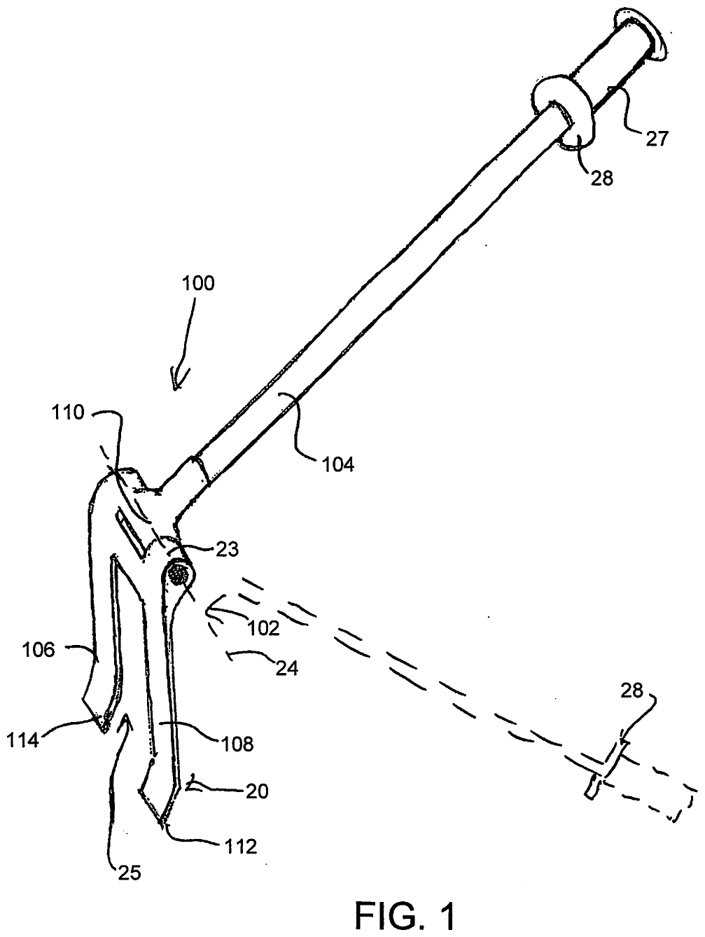

The width of the tines allows for the tines to straddle a wall stud, as discussed fully below. Thus, the width of about 2″ is used when the sheet rock is nailed to the 2″ side of a 2×4 stud, whereas the width of about 4″ is used when the sheet rock is nailed to the 4″ side of a 2×4 stud. In some embodiments, for example the one shown in FIG. 1, the plane where the handle attaches to the claws is offset from the plane of the tines. Thus, a wall stud can fit into the space defined by the tines 106 and 108 and the cross bar 110.

In some embodiments, the tines 106 and 108 are flat. In certain of these embodiments, the flat portion of the tines is in the generally distal section of the tines. In other embodiments, the entire length of each tie is flat. The flat tines are suitable for placing the tines behind the drywall sheet and provide a maximum contact area with the sheet for its removal.

In some embodiments, the tines 106 and 108 have sharp bladed edges 112 and 114, respectively. These sharp edges provide the means for a user to break through the drywall and create an opening slot across the wall into which the tines are inserted.

In some embodiments, a wedge is provided on the cross bar. The wedge is used to remove any nails from the studs.

The tines are curved at 20 so as to form a convex rear face 21 for engaging against the sheet material and a concave front face 211.

The handle 104 is connected to and extends from the cross bar or base 110 at a right angle to the cross bar.

The cross bar 110 includes a lockable swivel coupling 23 allowing the handle 104 to rotate about an axis 24 along the cross bar in a plane at right angles to the cross bar so as to change an angle of the handle relative to the tines.

Each of the tines can be curved along its full length. However more preferably each of the tines is curved at a position 20 adjacent the remote end 112 as shown in the Figures.

Each of the tines has a width of at least 1.0 inch and preferably 1.5 inch, a length of at least 9.0 inches, preferably 12 inches and which can be up to 14 inches.

The tines 106, 108 have a space 25 therebetween in the range 3.5 to 6 inches.

The length of the handle can be around 42 inches in length for optimum leverage and accessibility.

Each of the tines can have a constant width as shown in FIG. 3.

As shown in FIG. 1 in dash line the tool can be used with the handle 104, as locked by the swivel coupling 23 at an angle less than 90 degrees to the tines for pulling upwardly to lever off a sheet below the tines.

As shown in FIG. 1 the tool can be used with the handle at an angle greater than 90 degrees to the tines for pushing downwardly to lever off a sheet above the tines.

As shown there is provided a pointed abutment 26 at the cross bar facing away from the rear face of the tines for engaging into the stud to prevent sliding of the cross bar and thus of the tines relative to the stud.

As shown in each of the Figures, the handle comprises an elongate bar with a manually graspable handle portion 27 at the outer end, the handle portion including a cross-bar or quillon 28 facing toward the crossbar 110 and the swivel coupling 23 to protect the hand against any material sliding along the elongate bar 104.

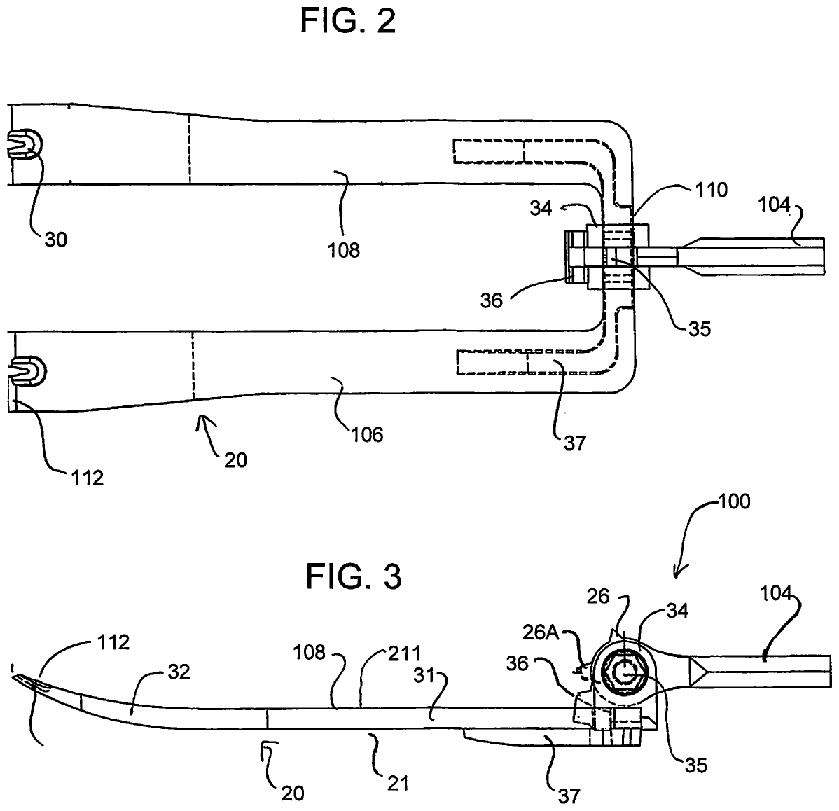

As best shown in FIG. 2, the remote end 112 of each of the tines 106, 108 includes a chamfered recess 30 at the end edge for receiving a nail head to enable the tine to be used to lever nails out from the stud.

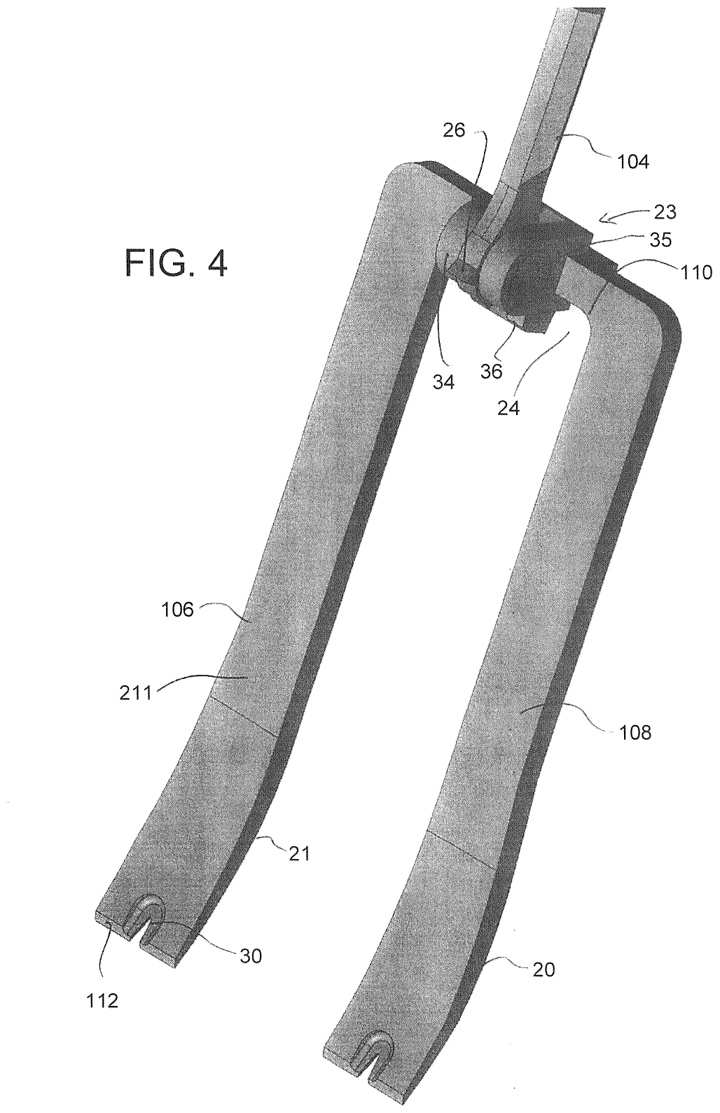

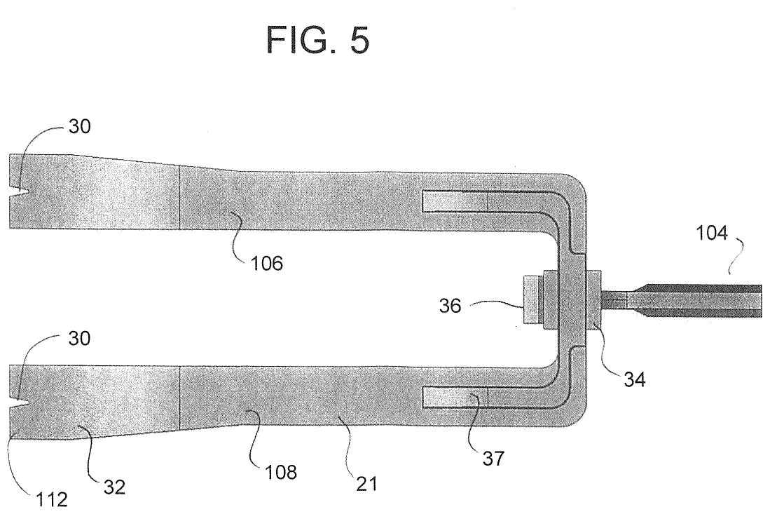

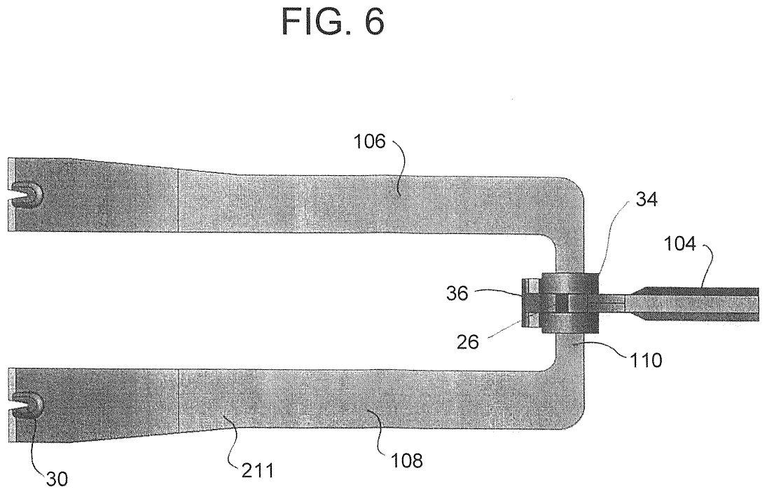

As best shown in FIGS. 3 and 4, each of the tines 106, 108 includes a substantially flat portion 31 adjacent the base 110 extending outwardly from the base and has a curved portion 32 extending from the flat portion 31 to a position adjacent the remote end 112. Each of the tines has a substantially constant width along the flat portion 31 and increases in width from the flat portion along the curved portion 32. The curved portion also tapers in thickness toward the end edge.

As shown best in FIG. 4, he cross bar 110 includes a raised hub 34 on the front face 211 and the swivel coupling 23 includes a transverse swivel shaft 35 on which the handle 104 is mounted. The swivel shaft can rotate in the raised hub to take up different positions of the handle around the axis 24. A manually operable locking device 36 is provided on the handle to locate the handle at the required angle.

The pointed abutment 26 is mounted on the handle 104 at the cross bar for engaging into the stud to prevent sliding relative to the stud. The pointed abutment at the cross bar extends in the direction of the front face 211 so as to engage the stud as the convex rear faces engage the drywall. The abutment is triangular in cross-section to provide a sharp apex to engage into the stud. It has a width substantially equal to the width of the handle at the hub on the swivel shaft. The location of the projection around the axis of the hub can be as shown at 26 or more preferably is at the position aligned with the length of the handle as shown in dash line at 26A. at this location the top and bottom of the handle at the hub are smooth and the projection or tang 26 is moved into operation when the handle is in its operating position at around 45 degrees to the face of the tines.

As best shown in FIGS. 2 and 3, the U-shaped member defining the base 110 and the tines has a stiffening rib 37 on the rear face each of the tines 106, 108 and the cross bar 110.

1. A leverage tool for removing a sheet material from supporting studs comprising:
a handle; and
a generally U-shaped body including a pair of spaced apart tines connected to a cross bar so that the times extend in parallel arrangement away from the cross bar to a remote end of the tine for engagement of the pair of tines side by side into a position behind the sheet material;
the tines being spaced by a distance to receive one of the studs therebetween;
the tines having a front face and a rear face and being curved so as that the front face is concave and the rear face is convex for engaging against the sheet material;
wherein the handle is connected to and extends from the cross bar at a right angle to the cross bar;
wherein the cross bar includes a lockable swivel coupling allowing the handle to rotate about an axis along the cross bar in a plane at right angles to the cross bar so as to change an angle of the handle relative to the tines.

2. The leverage tool according to claim 1 wherein the remote end of each of the tines comprises a sharp bladed edge parallel to the cross bar.

3. The leverage tool according to claim 1 wherein the remote end of each of the tines includes a recess for receiving a nail head.

4. The leverage tool according to claim 1 wherein each of the tines is curved along its full length.

5. The leverage tool according to claim 1 wherein each of the tines includes a substantially flat portion adjacent the base and has a curved portion extending from the flat portion to a position adjacent the remote end.

6. The leverage tool according to claim 1 wherein each of the tines has a substantially constant width along the flat portion and increases in width from the flat portion along the curved portion.

7. The leverage tool according to claim 1 wherein each of the tines has a width of at least 1.0 inch and preferably at least 1.5 inch.

8. The leverage tool according to claim 1 wherein each of the tines has a length of at least 9.0 inches and preferably at least 12 inches.

9. The leverage tool according to claim 1 wherein the tines have a space therebetween in the range 3.0 to 6.0 inches.

10. The leverage tool according to claim 1 wherein each of the tines has a substantially constant width.

11. The leverage tool according to claim 1 wherein the lockable swivel coupling defines a locked position with the handle at an angle less than 90 degrees to the tines for pulling upwardly to lever off a sheet below the tines.

12. The leverage tool according to claim 1 wherein the lockable swivel coupling defines a locked position with the handle at an angle greater than 90 degrees to the tines for pushing downwardly to lever off a sheet above the tines.

13. The leverage tool according to claim 1 wherein there is provided a pointed abutment at the cross bar for engaging into the stud to prevent sliding relative to the stud.

14. The leverage tool according to claim 13 wherein the pointed abutment at the cross bar extends therefrom in the direction of the front face.

15. The leverage tool according to claim 13 wherein the pointed abutment is mounted on the handle.

16. The leverage tool according to claim 1 wherein the cross bar includes a raised hub on the front face and wherein the swivel coupling includes a swivel shaft on which the handle is mounted.

17. The leverage tool according to claim 16 wherein there is provided a pointed abutment at the cross bar for engaging into the stud to prevent sliding relative to the stud and wherein the pointed abutment is mounted on the handle at the swivel shaft.

18. The leverage tool according to claim 1 wherein the handle comprises an elongate bar with a manually graspable handle portion at the outer end, the handle portion including a cross-bar or quillon to protect the hand.

19. The leverage tool according to claim 1 wherein the U-shaped member has a stiffening rib on the rear face each of the tines and the cross bar.
